(19) United States
(12) Patent Application Publication
(10) Pub. No.: US 2016/0023369 A1
(43) Pub. Date: Jan. 28, 2016

(54) WASTE STRIPPING AND CUTTING ARRANGEMENT, CASSETTE, UNIT AND MACHINE PROVIDED THEREWITH

(71) Applicant: BOBST MEX SA, Mex (CH)

(72) Inventors: Sylvain BAPST, Bulle (CH); Guillaume DÉNISSE, Féternes (FR)

(21) Appl. No.: 14/773,411

(22) PCT Filed: Mar. 5, 2014
(86) PCT No.: PCT/EP2014/000560

§ 371 Date: Sep. 8, 2015

(30) Foreign Application Priority Data
Mar. 8, 2013 (EP) 13001173.7

(51) Int. Cl. B26D 7/18; B26F 1/38

(52) U.S. Cl. CPC B26D 7/1836; B26F 1/384; B26D 2007/1809

(57) ABSTRACT

An arrangement for cutting off and ejecting waste from a planar support (3), includes a first rotating cylindrical tool for ejecting waste (16), the surface of which has at least one radial, waste-retaining needle, a second rotating cylindrical tool (17), first and second side bearings (26, 27), holding the first tool (16) for rotation, third and fourth side bearings (29, 31), holding the second tool (17) for rotation, and at least one ejector (39); the two tools (16, 17) and the ejector (39) cooperating to eject the waste from the support (3). The ejector (39) is fixed transversely to a lower portion of the first and second bearings (26, 27) respectively.

### CROSS-REFERENCE TO RELATED APPLICATIONS

The present application is a 35 U.S.C. §§371 national phase conversion of PCT/EP2014/000560, filed Mar. 5, 2014, which claims priority of European Patent Application No. 13001173.7, filed Mar. 8, 2013, the contents of which are incorporated by reference herein. The PCT International Application was published in the French language.

The present invention relates to a waste stripping and cutting arrangement from a flat substrate, and used with two cylindrical tools in a machine for producing packaging, to a waste stripping and cutting cassette, comprising a waste stripping and cutting arrangement, to a converting unit for a flat substrate equipped with a waste stripping and cutting cassette, to a converting unit for a flat substrate comprising a waste stripping and cutting arrangement, and to a machine for producing packaging from a flat substrate comprising at least one converting unit for the flat substrate.

A machine for producing packaging is intended for the manufacture of boxes which form packaging after folding and gluing. In said machine, an initial flat substrate such as a continuous web of cardboard is unrolled and is printed via a print unit including sets of printing units. The web is then transferred into a converting unit to manufacture plate-like elements, in this case boxes.

The converting unit comprises at least one converting arrangement provided with two cylindrical rotary tools positioned parallel to one another so as to cooperate. The web defines a substrate that advances in the gap between the two tools for the substrate to be transformed there. The two tools rotate in opposite directions to one another. The first tool is rotatably mounted in first and second spaced apart bearings. The second tool is rotatably mounted in third and fourth spaced apart bearings. Clamping elements hold the first and the third bearings together firmly, and hold the second and the fourth bearings together firmly. The converting arrangement is usually provided so as to form a cassette. The cassette is inserted by sliding it into each of the lateral frames of the unit.

The cassette enables a rapid change of the tools, which are selected according to the transformations of the substrate to be carried out. The packaging manufacturer has a minimum of two cassettes. A first cassette is in the machine during production and is configured according to the converting work then being undertaken. During this time, a second cassette is being assembled and adjusted, so as to be configured according to requirements of the next converting task. To change the task, the operator removes the old cassette and inserts the new cassette, and with this arrangement, reduces the stoppage time of the machine to a minimum.

For example, one of the arrangements or one of the cassettes is a rotary waste stripping and cutting arrangement or is a rotary waste stripping and cutting cassette. The cardboard blanks being formed from the web passing the tools have areas of waste cardboard which are cut by the tools, and then immediately separated and removed so as to be able to create the boxes from the remainder of the web.

The arrangement for the cutting and stripping ensures a controlled, accurate and rapid stripping of waste. The precision of the operation of the arrangement for the cutting and stripping enables all waste to be disposed of and jamming to be avoided. The arrangement for the cutting and stripping comprises two tools in the form of two rotary cylinders positioned parallel to one another so as to cooperate with one another. The web, consisting of blanks to be cut, runs through the gap between the two tools, following a trajectory which is tangential to said tools.

As is disclosed, for example, in the document EP-1'057'596, the first cylindrical tool comprises needles inserted radially in its surface. The needles are placed at precise locations corresponding to the layout of the blank and particularly to pierce each item of waste. The needles separate the waste from each blank and thus from the web by driving the waste along a circular trajectory along with the rotation of the first tool comprising needles, while the web moves away from the first tool.

The second cylindrical tool ensures both the cutting and the transport of the blanks and the retention of the blanks when piercing the waste. The second tool is provided with blades or fillets positioned for cutting a shaped blank as the tools rotate. Radial holes are perforated in the metal surface of the second tool, outside the blades. The positions of the holes correspond to the positions of the needles of the first tool. The needles are temporarily housed in the holes during the rotation of the two tools, so that the needles pierce and perforate the waste in an effective manner. Several buffers made of a flexible material, for example foam, are arranged between the blades and outside the holes. The buffers pull the web, including its boxes.

This waste is then released from the needles during rotation of the first tool. To this end, a series of ejectors in the form of fixed combs with one or more slots is arranged parallel to the first tool. The rectilinear edge of the combs is parallel to the generatrix of the cylinder of the first tool.

The combs are placed laterally relative to one another on the second tool so that one of the slots between teeth of the comb coincides with the lateral position and thus with the circular trajectory of one of the needles on the first tool for the purpose of avoiding any collision between the needles and combs. The waste cut by the second tool is captured by the combs and torn from the needles when the first tool rotates. The needles are thus released from waste they have collected and are pushed into further waste the next time they pass into the area cut from the following blank.

The edge of the comb has to be positioned at a very precise distance from the first tool, in the order of a hundredth of a millimeter, for example. If the operator permits a too great spacing between the surface of the cylinder and the edge of the comb, there is a risk that the waste may pass between the comb and the surface. This may initially cause a deformation of the comb and may also break one or more needles. Generally, the waste gradually impedes the rotation of the cylinder until the machine stops. If, on the other hand, the spacing is too small, the comb risks deteriorating and damaging the first tool.

### PRIOR ART

The combs are fixed to the frame by means of a guide crossmember. The crossmember is in turn fixed by means of lower components comprising studs and lugs, attached below the bearings.

When the operator has to adjust the combs of an arrangement or a cassette for the cutting and stripping, following a loss of adjustment or a change of task, the operator removes the arrangement or the cassette from the converting unit of the installation. The arrangement or the cassette is then placed on an adjustment table outside the converting unit. The arrangement or the cassette then rests on the adjustment table via its components.

Once the adjustments have been carried out, the arrangement or the cassette is replaced in the unit. During the adjustment, the arrangement or the cassette has been positioned via its components. The arrangement or the cassette rests in the unit via its upper bearings and no longer via the components. The addition of tolerances of the components here thus may cause a loss of adjustment of the combs.

### SUMMARY OF THE INVENTION

A principal object of the present invention is developing a waste stripping and cutting arrangement from a flat substrate, designed for use in a converting unit in a machine for producing packaging. A second object is to produce a waste stripping and cutting arrangement using rotary tools, enabling extremely accurate adjustment to be obtained of the spacing between one of the tools bearing needles and the ejectors. A third object is to avoid variations in the adjustment of an arrangement for the cutting and stripping between the adjustment table and the converting unit. A fourth object is to resolve the technical problems mentioned above for arrangements of the prior art. A fifth object consists in providing a cassette comprising a waste stripping and cutting arrangement. A further object is achieving the insertion of a converting unit into a machine for producing packaging.

A waste stripping and cutting arrangement from a flat substrate comprises a first cylindrical rotary tool configured for ensuring the cutting and stripping of waste. The surface of the first cylindrical rotary tool is provided with at least one radial needle for retaining cut off waste. The waste stripping and cutting arrangement from the flat substrate comprises a second cylindrical rotary tool. The waste stripping and cutting arrangement from the flat substrate also comprises a first lateral bearing and a second lateral bearing spaced apart both radially and along the tool axis. The first and second lateral bearings hold the first tool for rotation. The waste stripping and cutting arrangement from the flat substrate also comprises a third lateral bearing and a fourth lateral bearing spaced apart both radially and along the tool. The third and the fourth lateral bearings hold the second tool for rotation. The waste stripping and cutting arrangement from the flat substrate comprises at least one ejector. The two tools and the ejector are arranged and cooperate with one another to cut, retain and eject the waste from the flat substrate.

According to one feature of the present invention, the waste stripping and cutting arrangement from the flat substrate comprises means for joining the ejector. The means for joining are attached transversely in the region of a lower part, respectively of the first lateral bearing and the second lateral bearing.

The ejector or the ejectors are attached directly to the two bearings of the tool bearing the needles via transverse means for joining. The means for joining comprise few parts and are compact. Due to the direct attaching to the bearings, a very high degree of rigidity is obtained both statically and dynamically. An adjustment carried out on an adjustment table remains the same as when the arrangement is located in the machine.

The flat substrate is defined, by way of non-limiting example, as being comprised of a material in a continuous web, such as of paper, flat cardboard, corrugated cardboard, laminated corrugated cardboard, flexible plastics material, for example polyethylene (PE), polyethylene terephthalate (PET), biaxially oriented polypropylene (BOPP) or other materials.

A waste stripping and cutting arrangement from the flat substrate and a cassette thereof having one or more technical features described below used for the cutting and stripping, provides access, mounting and the dismantling of the radial needle or needles for retaining waste and the ejector or ejectors are facilitated for the operator, providing the adjustment and retention of the unit and the machine for producing packaging.

A converting unit for a flat substrate is equipped with a waste stripping and cutting cassette from the flat substrate. The cassette has a waste stripping and cutting arrangement from the flat substrate, having one or more of the technical features described below.

A machine for producing packaging from a flat substrate comprises at least one converting unit for the flat substrate, having one or more of the technical features described below.

### BRIEF DESCRIPTION OF THE DRAWINGS

The invention will be understood and various advantages and different features thereof will emerge more clearly during the following description of the non-limiting embodiment, with reference to the accompanying schematic drawings, in which:

FIG. 1 shows a schematic lateral view of a converting unit;

FIG. 2 shows an isometric oblique view of a cassette provided with a waste stripping and cutting arrangement according to the invention;

FIG. 3 shows a partial lateral view of the cassette of FIG. 2; and

FIG. 4 shows a sectional view along the plane IV-IV in FIG. 2, with two tools of different diameters.

### DETAILED DESCRIPTION OF PREFERRED EMBODIMENTS

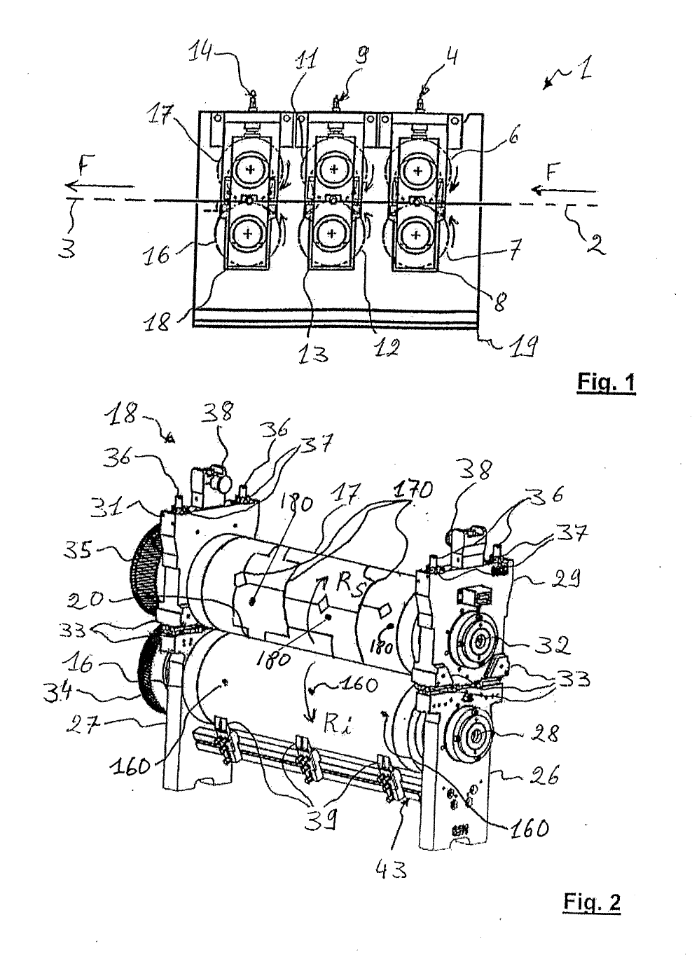

A machine for producing packaging (not fully shown) processes a flat material or substrate which in this case is a substrate made of a continuous web, for example made of flat cardboard. As FIG. 1 illustrates, the machine comprises a converting unit of a substrate 1 for transforming the web 2. The forward direction or the direction of travel (arrow F in FIG. 1) of the web 2 and of the transformed web in the longitudinal direction indicates the upstream direction and the downstream direction in the unit 1. The front and rear positions are defined relative to the transverse direction as being respectively the driver or operator side and the side opposite the operator side.

The machine may have known elements, such as a web unwinder, units such as sets of printers, means for monitoring the printing quality and range, a web guide and further means which are positioned upstream of the converting unit 1.

The converting unit 1 is a unit for embossing, scoring, cutting and ejecting waste. The web 2 arrives in the unit 1 with its transverse side upstream, at a constant speed. An introductory group comprising drive rollers and return rollers for the web 2 is provided at the inlet of the unit 1. The unit 1 transforms the web 2 successively by embossing the strip, cutting the web and ejecting the waste.

The unit 1 delivers blanks or transformed boxes 3, which are made of flat, embossed, scored, cut cardboard, and without waste. The boxes 3 leave the unit 1 by their downstream transverse side, at the same constant speed. The boxes 3 manufactured in the unit 1 are then separated laterally and longitudinally from one another in a separating station, and are then received in a receiving station (not shown).

The unit 1 initially comprises a first arrangement providing the embossing 4, which is arranged upstream, i.e. at the inlet of said unit 1. The embossing arrangement 4 is equipped with an upper rotary embossing tool 6 and a lower rotary embossing tool 7. In the exemplary embodiment, an embossing cassette 8 comprises the embossing arrangement 4.

The unit 1 comprises a second arrangement providing the scoring 9, arranged downstream of the embossing arrangement 4. The scoring arrangement 9 is equipped with an upper rotary scoring tool 11 and a lower rotary scoring tool 12. In the exemplary embodiment, a scoring cassette 13 comprises the scoring arrangement 9.

The unit 1 comprises a third arrangement for providing the cutting and stripping of waste 14 and it is arranged downstream of the scoring arrangement 9, i.e. at the outlet of the unit 1. The waste stripping and cutting arrangement 14 is provided with a first lower rotary tool for ejecting waste 16 and which is positioned parallel to a second upper rotary tool for the cutting and stripping of waste 17. In the exemplary embodiment, a waste stripping and cutting cassette 18 comprises the waste stripping and cutting arrangement 14.

The arrangements 4, 9 and 14 and thus the cassettes 8, 13 and 18 are positioned one after the other so that each carries out its respective converting by embossing, scoring, cutting and ejecting waste from the web 2.

The axis of rotation of each of the tools for embossing 6 and 7, scoring 11 and 12 and cutting and ejecting waste 16 and 17 is oriented transversely relative to the direction of travel F of the web 2. The direction of rotation (arrow Rs in FIG. 2) of the upper tools for embossing 6, scoring 11 and cutting and ejecting waste 16 is reversed relative to the direction of rotation (arrow Ri in FIG. 2) of the lower tools for embossing 7, scoring 12 and cutting and ejecting waste 17.

The cassettes for embossing 8, scoring 13 and cutting and ejecting waste 18 respectively, are configured for being introduced into a frame 19 of the unit 1, being fixed to the frame 19, put into production and then, in reverse, configured for being detached from the frame 19 and removed from the frame 19. The unit 1 thus comprises three transverse housings provided in the frame 19 respectively for each of the three cassettes 8, 13 and 18. The cassettes 8, 13 and 18 are introduced vertically from the top relative to the frame 19 into the transverse housings. In reverse, the cassettes 8, 13 and 18 may be removed vertically relative to the frame 19 from their respective transverse housing.

The waste stripping and cutting arrangement 14 and as a result the waste stripping and cutting cassette 18 comprises (see FIG. 2) the first lower cylindrical rotary tool 16 which is provided with a plurality of radially extending needles 160 with widened external heads which needles are inserted radially into the surface of cassette 18. The needles may be in any array and are shown, for example, in one and, more preferably, several axial direction rows at circumferentially spaced intervals. The radial needles all protrude radially over an equal length. The tips of the needles are oriented to the outside. The remainder of the circumference of the first tool 16 is smooth.

The radial needles 160 are placed in an appropriate manner in locations where the cutting of the web 2 produces waste, as a function of the layout of the blanks provided in the web 2. Immediately after cutting, each item of waste (not shown) is pierced by a radial needle. The boxes 3 follow their horizontal trajectory F while and the waste that was cut from the web is now held to the needles and is driven in a circular trajectory Ri about the lower tool 16 and is thus separated from the boxes 3.

The second upper cylindrical rotary tool 17 is provided with cutting fillets 170 (FIG. 2) machined into or attached over the circumference of the tool 17 as a function of the configuration of the boxes to be produced. Holes 180 are perforated in the upper tool 17 at locations to correspond with the positions of the needles of the first tool 16 as both tools 16 and 17 rotate past each other. Several buffers made of foam may be adhesively bonded in the areas of the tools axially along the tools outside the fillets and the holes. The web 2 is driven and travels F in the radial spacing 20 or gap between the lower tool 16 and the upper tool 17. The lower tool 16 cooperates with the upper tool 17 to carry out the converting, i.e. to cut and eject the waste from the web 2.

The waste stripping and cutting arrangement 14 and as a result the waste stripping and cutting cassette 18 comprises a first lower front (operating sides) bearing 26 and a second lower rear (machine side) bearing 27, spaced apart and toward the ends of the first tool holding the first tool for the purpose of rotation, i.e. the lower tool 16 by its axis of rotation 28. The arrangement for the cutting and stripping 14 and as a result the cassette for the cutting and stripping 18 also comprises a third upper front bearing 29 and a fourth upper rear bearing 31, spaced apart and toward the ends of the second tool holding the second tool for the purpose of rotation, i.e. the upper tool 17 by its axis of rotation 32.

A lower part of each of the third and fourth bearings 29 and 31 has four protrusions 33. The lower part of the bearings 29 and 31 corresponds to the area located below the axis of rotation 32. Two protrusions upstream and downstream are present on the front face and two protrusions upstream and downstream are present on the rear face. The waste stripping and cutting cassette 18 rests on the frame 19 due to eight protrusions 33 of each of the two upper bearings 29 and 31, when it is inserted into the unit 1.

The waste stripping and cutting arrangement 14 and as a result the waste stripping and cutting cassette comprises drive means designed to drive the two tools 16 and 17 in rotation. The drive means are formed with a first lower pinion 34 for the lower tool 16 fixed at the rear on its axis of rotation 28. Said first pinion 34 meshes with a second pinion 35 for the upper tool 17 fixed at the rear on its axis of rotation 32. When the cassette 18 is inserted into the frame 19, the teeth of the second pinion 35 mesh with the teeth of a pinion connected to an electric motor for driving in rotation.

The first lower front bearing 26 of the lower tool 16 is fixed to the third front bearing 29 of the upper tool 17 and the second lower rear bearing 27 of the lower tool 16 is fixed to the fourth upper rear bearing 31 of the upper tool 17, so as to constitute the cassette for cutting 18. To retain the cassette 18 in one piece, elements in the form of four stud bolts 36 respectively pass through the upper front bearing 29 and the upper rear bearing 31 on both sides of the axis of rotation 32 of the upper tool 17. The lower end of each of the four stud bolts 36 is threaded and screwed into a tapped portion of the lower front bearing 26 and of the lower rear bearing 27. Four nuts 37 are respectively screwed on the upper end of the four stud bolts 36 and lock the stud bolts in position by bearing against an upper face of the upper front bearing 29 and of the upper rear bearing 31.

The waste stripping and cutting cassette 18, in addition to the cassettes for embossing 8 and scoring 13, comprise two gripping lugs 38, each provided in the region of the upper face of the upper front bearing 29 and of the upper rear bearing 31. The two lugs 38 are designed to cooperate with lifting means (not shown) to raise vertically and to transport the cassette 18, 8 and 13 away from the frame 19.

A controlled stripping of the waste is carried out by the waste stripping and cutting arrangement 14 and by the waste stripping and cutting cassette 18. The waste pierced by the radial needle is detached from the same needle, so that the needle is thereafter able to extract further waste with each rotation of the lower tool 16. This extraction is carried out using at least one ejector, in the form of an ejection comb 39 (see FIGS. 2 to 4). Preferably, there is a respective comb positioned axially along the tool 16 at locations where there is a respective pin 160 which may be carrying cut off waste. The two tools 16 and 17 and the comb 39 are arranged and cooperate with one another to eject the waste from the web 2.

The comb 39 comprises a slot 41 oriented perpendicular to the front edge 42 of the comb 39 and the first edge is parallel to the generatrix of the lower tool 16. This slot 41 is arranged on the circular trajectory described by each respective axially aligned radial needle 160 about the axis of rotation 28 of the lower tool 16. The angle of inclination of the comb 39 and the length of the slot 41 are provided to permit the passage of each radial needle past the respective comb. The front edge 42 of the comb 39 is thus able to come very close to the surface of the lower tool 16 which enables it to engage between the surface and the waste and raise the waste off the then respective needle passing a comb.

According to the invention, the waste stripping and cutting arrangement 14 and also the waste stripping and cutting cassette 18 comprises means for joining 43 the ejector, i.e. the comb 39, fixed transversely in the region of a lower part respectively of the first lower front bearing 26 and of the second lower rear bearing 27. The lower part of the bearings 26 and 27 corresponds to the area located below the axis of rotation 28 of the lower tool 16. Due to the piercing of the waste, the means for joining 43 are fixed in the lower part located downstream.

The waste stripping and cutting arrangement 14 and also the waste stripping and cutting cassette 18 may be used with tools 16 and 17 having different diameters corresponding to the length of the blanks for the task carried out. A first tool with a small diameter 16 and a first tool with a greater diameter 16a (in dashed dotted lines) with the means for joining 43 thereof and the comb 39 thereof have been shown in FIG. 4.

The means for joining 43 preferably adopt a position on the first bearing 26 and the third bearing 27 which is selected such that the distance between the means for joining 43 and the first tool 16 and 16a is substantially equivalent, whatever the diameter of the first tool 16 and 16a.

Advantageously, the means for joining 43 comprise a crossmember 44, for example of quadrangular section. The crossmember 44 ensures the coupling between the first bearing 26 and the third bearing 27 which enables the two bearings 26 and 27, the waste stripping and cutting arrangement 14 and also the waste stripping and cutting cassette 18 to be rigidified.

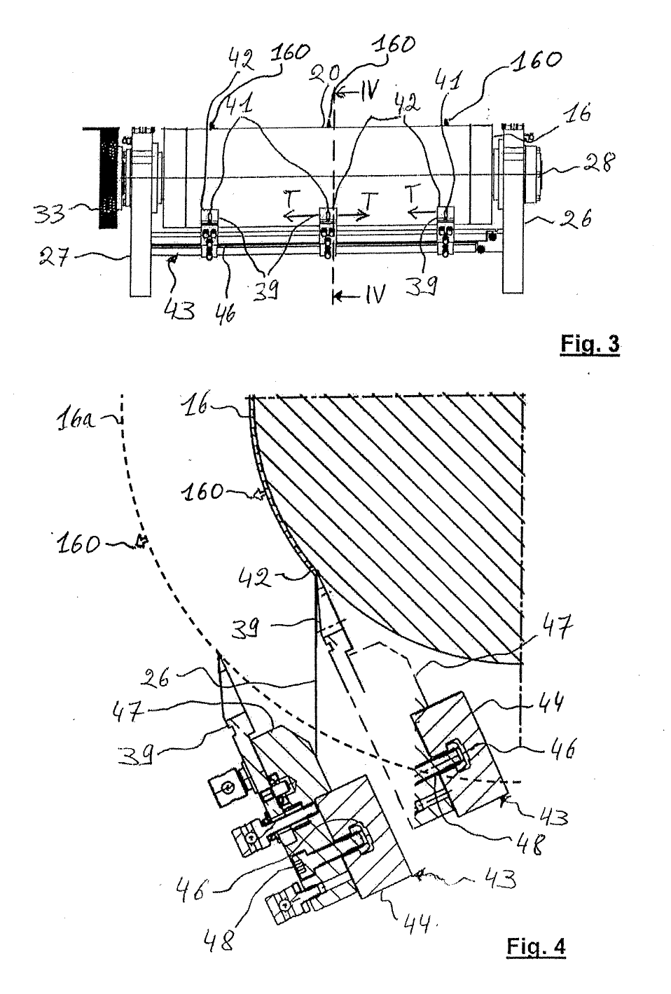

The means for joining 43 advantageously comprise a slide. The slide forms an integral part of the crossmember 44. The slide permits a transverse positioning by sliding (arrow T in FIG. 3) and a mechanical connection of the ejector, i.e. of the comb 39.

Preferably, the slide has a groove 46 formed in the crossmember 44. The groove 46 is formed by being oriented substantially to the outside of the waste stripping and cutting arrangement 14 and thus of the waste stripping and cutting cassette 18. The groove 46 opens downstream and downwardly. The groove 46 is designed for the positioning and mechanical connection of the ejector, i.e. of the comb 39. Due to its orientation, the groove 46 is easily accessible to the operator.

The means for joining 43 advantageously comprise an adaptor 47 providing a mechanical connection of the ejector, i.e. of the comb 39 such that the ejector, i.e. the comb 39 adopts the same angular position, whatever the diameter of the first tool 16 and 16a.

Several adaptors 47 are positioned along the crossmember 44 according to the respective positions and the number of items of waste to be removed at each revolution of the first tool 16 and 16a. Each of the adapters 47 carries a comb 39. Advantageously for the lateral adjustment, the means for joining 43 comprise a part forming a slide 48 providing a connection with the adaptor 47 and cooperating with the groove 46 of the slide.

The adjustment of the position of the comb 39 on the adaptor 47 in its two axes of displacement is obtained using adjusting screws which are accessible on the same face of the adaptor 47 oriented parallel to the slide, i.e. to the crossmember 44. The adjusting screws are thus easily accessible as they are oriented downwardly and downstream. The adjustment and the dismantling of the combs 39 and the adaptors 47 simplify to a maximum the various operations on the waste stripping and cutting arrangement 14 and thus on the waste stripping and cutting cassette 18.

A protective cover (not shown) extending over the entire length of the first tool 16 covers the means for joining 43. The cover enables the combs 39, the adaptors and their attachments to be protected, while channeling the flow of waste.

The present invention is not limited to the embodiments described and illustrated. Numerous modifications may be made without departing from the field of the invention defined by the scope of the set of claims.

1. A waste stripping and cutting arrangement from a flat substrate, comprising:
a first cylindrical rotary tool for ejecting waste stripped and cut from the substrate, the first tool having a surface thereon with at least one radial needle and the needle is configured for retaining waste on the at least one needle;
a second cylindrical rotary tool parallel to the first tool and defining a radial gap between the first and second tools;
a first lateral bearing and a second lateral bearing holding the first tool for the purpose of rotation, the first and second tools being spaced apart along the first tool;
a third lateral bearing and a fourth lateral bearing holding the second tool for the purpose of rotation, the third and fourth tools being spaced apart along the second tool;
at least one ejector configured for removing waste from the at least one radial needle, the first and second tools and the ejector being arranged, configured, and cooperating with one another for the cutting of the substrate and the stripping waste produced from the substrate by the cutting and stripping; and
means for joining the ejector attached transversely of the substrate and the ejector is located in a region of a lower part, respectively of the first bearing and the second bearing.

2. An arrangement according to claim 1, further comprising the means for joining have an adjustable position on the first bearing and on the second bearing such that a distance between the means for joining and the first tool is equivalent as a diameter of the first tool is varied.

3. An arrangement according to claim 1, further comprising the means for joining comprise a slide movable with reference to the bearings in a manner enabling a transverse positioning of the slide by sliding and a connection of the ejector.

4. An arrangement according to claim 3, further comprising the slide has a groove oriented substantially to the outside of the arrangement, and configured for the connection of the ejector.

5. An arrangement according to claim 2, further comprising the means for joining comprise a crossmember in the direction between the bearings.

6. An arrangement according to claim 4, further comprising the means for joining comprise an adaptor configured for providing a mechanical connection of the ejector such that the ejector adopts the same angular position to the first tool, whatever is the diameter of the first tool.

7. An arrangement according to claim 6, further comprising the means for joining comprise a connecting piece with the adaptor and cooperating with the groove of the slide.

8. An arrangement according to claim 1, further comprising the second tool has a second surface thereon, holes being perforated in the second surface at positions corresponding to respective positions of the at least one of the needles of the first tool when the tools are rotated, such that each of the needles projects into and rises out of the hole in the second surface as the tools rotate and each of the needles passes the respective hole.

9. An arrangement according to claim 1, further comprising the second tool is provided with cutting fillets.

10. A waste stripping and cutting cassette from a flat substrate, which comprises an arrangement according to claim 1.

11. A converting unit for a flat substrate, comprising a cassette according to claim 10.

12. A converting unit for a flat substrate, comprising an arrangement according to claim 1.

13. A unit according to claim 12, comprising an arrangement for embossing and/or an arrangement for scoring positioned upstream of the arrangement.

14. (canceled)
